(19) United States
(12) Patent Application Publication
(10) Pub. No.: US 2022/0061367 A1
(43) Pub. Date: Mar. 3, 2022

(54) Method of Making Butter-Based Hot Sauce

(71) Applicant: Charles Johnson, Ithaca, NY (US)

(72) Inventor: Charles Johnson, Ithaca, NY (US)

(21) Appl. No.: 17/010,532

(22) Filed: Sep. 2, 2020

(51) Int. Cl. A23L 27/10; A23L 23/00; A23L 27/18; A23L 27/16

(52) U.S. Cl. CPC A23L 27/10; A23L 23/00; A23V 2002/00; A23L 27/18; A23L 27/16; A23L 27/105

(57) ABSTRACT

A method of making a butter-based hot sauce includes caramelizing a sugar element to create a caramel, and combining the caramel, an amount of a butter, and a pepper sauce.

### BACKGROUND OF THE INVENTION

### Field of the Invention

The present invention relates to a butter-based hot sauce and a method of making the sauce, and in particular, to a “buffalo chicken wing sauce” and method of making the sauce.

### Description of Related Art

Buffalo chicken wings were invented in Buffalo, N.Y. in the 1960's. The original recipe includes deep-frying chicken wings in oil, and then coating the wings in what became known as Buffalo wing chicken sauce, which in its original form includes a vinegar-based cayenne pepper hot sauce and melted butter. Many variations of chicken wing sauce have since been devised, but all forms of Buffalo chicken wing sauce include a chili sauce or pepper sauce, and butter.

Buffalo chicken wings were initially served in bars and restaurants, where the pepper sauce and the melted butter would be combined on site to form the Buffalo chicken wing sauce, which was then served to customers coating the chicken wings.

Over the years since their invention, buffalo chicken wings and buffalo chicken wing sauce became very popular. Buffalo chicken wing sauce became desirable to use with foods other than chicken wings. Due at least partly to the popularity of buffalo chicken wings and buffalo chicken wing sauce, attempts were made to commercially market Buffalo chicken wing sauce through grocery stores, for consumers to purchase and then use in their home kitchens.

Unfortunately, though, attempts to reproduce Buffalo chicken wing sauce failed because butter was unable to be used as an ingredient. Butter is a water-in-oil emulsion resulting in an inversion of the cream, where the milk proteins are the emulsifiers. Butter remains a firm solid when refrigerated, softens to a spreadable consistency at room temperature, and melts to a thin liquid consistency around 90 to 95 degrees Fahrenheit (32-35 degrees Celsius). At temperatures colder than the melting point of butter, butter proteins coagulate. When combined with pepper sauce and possibly other ingredients, bottled or otherwise packaged, and stored at room temperature or a refrigerated environment, the butter coagulates, thereby separating from the pepper sauce or other ingredients. This sauce with uneven consistency is unappealing to consumers both visually and functionally. An ability to pour the sauce from the bottle with even consistency is impeded, and the coagulated butter solids, when reheated, separate from the sauce, rendering it very oily and unappetizing.

To address this problem, for many years, commercial chicken wing sauce manufacturers have attempted to mimic Buffalo chicken wing sauce by substituting butter with oil and butter flavorings. The oil remains in liquid form, and often an emulsifier or stabilizer, like xanthan gum, is used to help create a smooth texture, and to keep the oil, the hot sauce, and any further vinegar from separating. Many faux Buffalo chicken wing sauces use butter-flavored hydrogenated or soybean oil as a substitute for butter. In other cases, the sauce is bottled sans butter or butter substitute, and consumers are instructed to add their own butter while heating over a stove when those consumers are ready to use the product.

The substitution of butter with oil and butter flavorings facilitates a consistently textured sauce, but unfortunately, detracts from the essential, original, desired flavor and texture that butter contributes to the sauce.

### SUMMARY OF THE INVENTION

A method of making a butter-based hot sauce utilizes butter as an ingredient, reduces or prevents separation and/or clumping of butter proteins, and facilitates a consistent texture and viscosity, such that the butter-based hot sauce can be bottled, stored, and reheated with an even consistency and texture.

In an embodiments, a method of making a butter-based hot sauce includes providing a pepper sauce; providing a sugar element; heating the sugar element to create a caramel; combining an amount of a butter with the sugar element or the caramel to form a butter caramel; and combining the butter caramel and the pepper sauce.

In another embodiment, a butter-based hot sauce includes a butter caramel and a pepper sauce, the butter caramel evenly blended with the pepper sauce, the butter caramel including a sugar element and an amount of butter.

In another embodiment, the method of making a butter-based hot sauce includes caramelizing a sugar element to create a caramel; and combining the caramel, an amount of a butter, and a pepper sauce.

### BRIEF DESCRIPTION OF THE DRAWING

FIG. 1 is a flow chart illustrating a method of making butter-based hot sauce, according to an embodiment of the invention.

FIG. 2 is an illustration showing a portion of the method of making the butter-based hot sauce, according to the embodiment of FIG. 1.

FIG. 3 is an illustration showing a portion of the method of making the butter-based hot sauce, according to the embodiment of FIG. 1.

FIG. 4 is an illustration showing a portion of the method of making the butter-based hot sauce, according to the embodiment of FIG. 1.

FIG. 5 is an illustration showing a portion of the method of making the butter-based hot sauce, according to the embodiment of FIG. 1.

### DETAILED DESCRIPTION OF THE INVENTION

The term “approximately”, as used herein, unless indicated otherwise, means the value indicated plus or minus 10 percent of the value indicated.

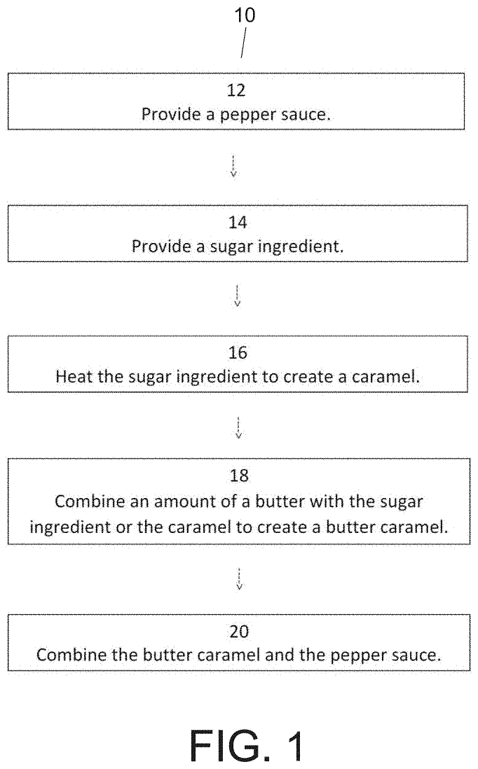

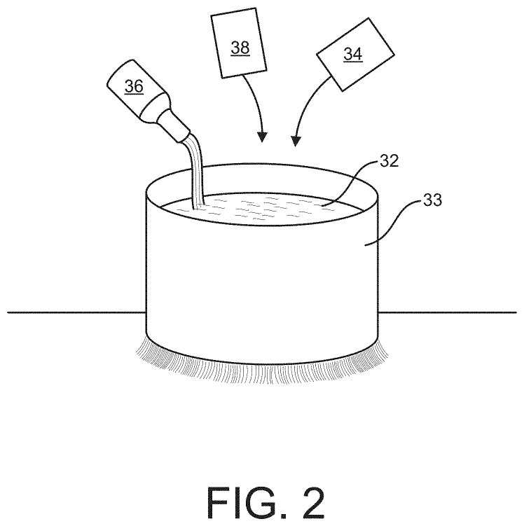

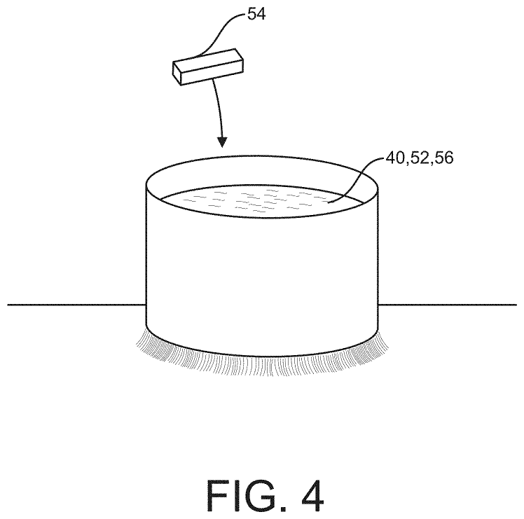

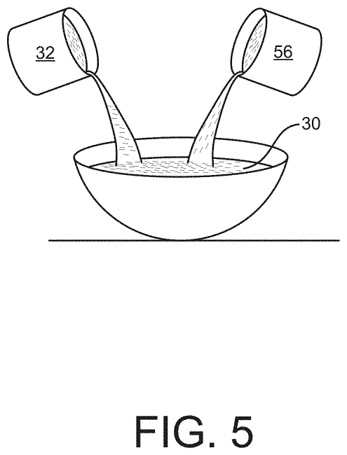

FIG. 1 is a flow chart illustrating a method 10 of making a butter-based hot sauce 30, according to an embodiment of the invention. FIGS. 2-5 pictorially illustrate the butter-based hot sauce 30 being made, according to the embodiment of FIG. 1. Referring to FIGS. 1-5, the method 10 of making the butter-based hot sauce 30 includes step 12—providing a pepper sauce 32. The pepper sauce 32 can be obtained commercially, pre-prepared and bottled for use, and then seasoned further if desired, or made from scratch by combining pepper sauce ingredients in a container 33. The pepper sauce 32 and its exact seasoning can vary greatly to achieve a desired flavor, but should include at least a chili pepper 34, such as but not limited to a cayenne pepper, a ghost pepper, and a habanero pepper. To the chili pepper 34, vinegar 36 can be added. Flavorings 38, such as but not limited to, fruits, vegetables, salt, garlic, black pepper, onion powder, mustard, or other spices can also be added to season and alter the taste of the pepper sauce 32. In some cases, pure capsaicin extract can be used in addition to or in substitution for the chili pepper 34. The pepper sauce 32 can be heated, in part, to marry all the ingredients, but for a duration short enough to avoid cooking off a significant amount of the vinegar 36.

The method 10 also includes step 14—providing a sugar element 40. The sugar element 40 can include granulated sugar 42, and/or corn syrup 44, or another sugar-based or sugar-dense ingredient 46, such as monk fruit, such that heating the sugar-based ingredient 46 produces a caramel. Water 48 and lemon juice 50 can also be included in the sugar element 40.

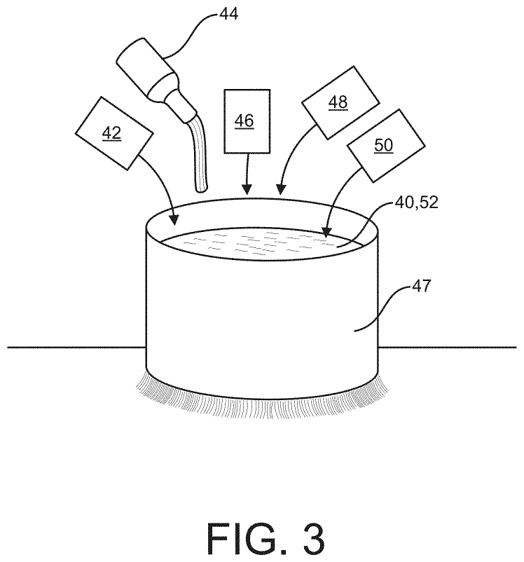

According to step 16, the sugar element 40 can be heated to create a caramel. FIG. 3 shows the sugar element 40 being put into and heated in a suitable container 47, such as a sauce pan or pot. In particular, the sugar element 40 can be heated until it reaches the brown-liquid stage of approximately 170 degrees Celsius (approximately 338 degrees Fahrenheit) with a concentrated sugar level of 100%. The browner the sugar the more intense the caramel flavor.

According to step 18, an amount of a butter 54 is combined with the sugar element 40 or the caramel 52. The butter 54 can be added after the water 48 evaporates from the sugar element 40 and the caramel 52 is formed, or the butter 54 can be added to the sugar element 40 while the water 48 is evaporating and the caramel 52 is forming. Ultimately, a butter caramel 56 is yielded and the butter 54 is stabilized such that when the butter 54 cools and congeals, the butter 54 remains consistently spread throughout the butter caramel 56 rather than forming large separate solids.

According to step 20, the butter caramel 56 and the pepper sauce 32 are combined. The portions can be sized to suit one's taste and desire. Approximately equal portions can produce a gastrique. Combining the butter caramel 56 and the pepper sauce 32 while one or both are still hot or warm can ease mixture of the two ingredients. The two ingredients can be thoroughly mixed to form the butter-based hot sauce 30 with even consistency. Whether hot or cold, the butter 54 remains consistently spread throughout the butter-based hot sauce 30, such that the butter-based hot sauce 30 looks appealing in a bottle, can be poured with uniform consistency from the bottle, and can be reheated without separation of the butter 54 from the pepper sauce 32.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of making a butter-based hot sauce, comprising:
providing a pepper sauce;
providing a sugar element;
heating the sugar element to create a caramel;
combining an amount of a butter with the sugar element or the caramel to form a butter caramel; and
combining the butter caramel and the pepper sauce.

2. The method of claim 1, further comprising heating the sugar element to a liquid stage before combining the amount of the butter and the sugar element.

3. The method of claim 2, wherein the sugar element is heated to at least 170 degrees Celsius.

4. The method of claim 1, wherein the sugar element includes one or more of lemon juice, water, and corn syrup.

5. The method of claim 4, further comprising heating the ingredient to a liquid stage until the sugar element reaches a concentrated sugar level of 100%.

6. The method of claim 1, wherein the butter caramel and the pepper sauce are combined before the butter caramel hardens.

7. The method of claim 1, wherein the butter caramel and the pepper sauce are combined before the butter caramel cools below approximately a melting point of butter.

8. The method of claim 1, wherein the sugar element includes a granulated white sugar.

9. The method of claim 1, wherein the pepper sauce comprises chili pepper and vinegar.

10. The method of claim 1, wherein an amount of the butter caramel by volume combined with the pepper sauce is approximately equal to an amount of the pepper sauce by volume combined with the butter caramel.

11. The method of claim 1, further comprising:
combining at least one of black pepper, garlic, salt, onion powder, barbecue sauce, ranch dressing, and mustard with at least one of the caramel, the pepper sauce, and the combination of the butter caramel and the pepper sauce.

12. A butter-based hot sauce comprising:
a butter caramel including a sugar element and an amount of butter, and
a pepper sauce,
the butter caramel evenly blended with the pepper sauce.

13. The butter-based hot sauce of claim 12, wherein the sugar element includes a granulated white sugar.

14. The butter-based hot sauce of claim 12, wherein the sugar element includes a syrup.

15. The butter-based hot sauce of claim 12, wherein the pepper sauce includes chili pepper and vinegar.

16. The butter-based hot sauce of claim 12, wherein an amount of the butter caramel is approximately equal to an amount of the pepper sauce.

17. A method of making a butter-based hot sauce, comprising:
caramelizing a sugar element to create a caramel; and
combining the caramel, an amount of a butter, and a pepper sauce.
